(19) United States
(12) Patent Application Publication
(10) Pub. No.: US 2021/0125059 A1
(43) Pub. Date: Apr. 29, 2021

(54) METHOD FOR TRAINING NEURAL NETWORK AND DEVICE THEREOF

(71) Applicant: Lunit Inc., Seoul (KR)

(72) Inventors: HyunJae LEE, Seoul (KR); Hyeonseob NAM, Seoul (KR)

(21) Appl. No.: 16/842,373

(22) Filed: Apr. 7, 2020

(30) Foreign Application Priority Data
Oct. 29, 2019 (KR) 10-2019-0135420

(51) Int. Cl. G06N 3/08; G06N 3/04

(52) U.S. Cl. CPC G06N 3/08; G06N 3/04

(57) ABSTRACT

Provided is a method for training a neural network and a device thereof. The method may train a neural network including first and second layers in a computing device. The method may include acquiring, at a processor of the computing device, a layer output of the first layer for training data and extracting, at the processor, statistics information of the layer output. The method may also include normalizing, at the processor, the layer output through the statistics information to generate a normalized output and augmenting, at the processor, the statistics information to generate augmented statistics information associated with the statistics information. The method may further include performing, at the processor, an affine transform on the normalized output using the augmented statistics information to generate a transformed output and providing, at the processor, the transformed output as an input to the second layer.

### CROSS-REFERENCE TO RELATED APPLICATION

This application claims the priority of Korean Patent Application No. 10-2019-0135420, filed on Oct. 29, 2019, in the Korean Intellectual Property Office, the disclosure of which is hereby incorporated by reference in its entirety.

### BACKGROUND

### Technical Field

The described technology relates to a method for training a neural network and a device thereof. More specifically, the described technology relates to a method for training a neural network that can improve the performance of the neural network for both an original domain and an augmented domain by changing a style thereof and a device to which the method is applied.

### Description of Related Technology

Neural networks are machine learning models that simulate the neuron structure of a human. A neural network consists of one or more layers, and the output data of each layer is used as an input to the next layer. Recently, researches on the utilization of a deep neural network composed of a plurality of layers have been actively conducted, and the deep neural network has been playing a crucial role in enhancing the performance of recognition in various fields such as speech recognition, natural language processing, lesion diagnosis, and so on.

Information represented by an image is primarily classified into content information and style information. In this case, the contents are encoded into a spatial configuration, and the styles are encoded into statistics information of feature activation.

Recent studies have concluded that the style information is more important than the content information in determining convolutional neural networks. Therefore, a method may be contemplated to improve the performance of a neural network by modifying the style information.

According to domain generalization, the more varieties of domains of a training set to be inputted to a device for training a neural network, the higher the performance of the device for training a neural network in the domains where the training set does not correspond.

Likewise, in the case of a style, the performance of the neural network can be improved for a new style by generating a variety of styles of training sets. However, a method of randomly changing styles may reduce the performance of the neural network for existing styles.

### SUMMARY

It is an aspect of the described technology to provide a method for training a neural network capable of maintaining high performance in both the original domain and a new domain of training data.

It is another aspect of the described technology to provide a computer program stored in a computer-readable recording medium for a device for training a neural network capable of maintaining high performance in both the original domain and a new domain of training data.

It is yet another aspect of the described technology to provide a device for training a neural network capable of maintaining high performance in both the original domain and a new domain of training data.

Objects to be achieved by the described technology are not limited to the list described above, and other aspects that have not been mentioned will be clearly understood by a person having ordinary skill in the art from the following description.

A method is provided for training a neural network in accordance with some embodiments of the described technology to achieve the aspects described above, and the method for training a neural network comprising first and second layers in a computing device, comprises: acquiring a layer output of the first layer for training data; extracting statistics information of the layer output; normalizing the layer output through the statistics information to generate a normalized output; augmenting the statistics information to generate augmented statistics information associated with the statistics information; performing an affine transform on the normalized output using the augmented statistics information to generate a transformed output; and providing the transformed output as an input to the second layer.

A computer program stored in a computer-readable recording medium in accordance with some embodiments of the described technology to achieve another aspect described above executes, in combination with a computing device: a step of acquiring a layer output of a first layer of a neural network for training data; a step of extracting statistics information of the layer output; a step of generating a normalized output by normalizing the layer output through the statistics information; a step of generating augmented statistics information associated with the statistics information by augmenting the statistics information; a step of generating a transformed output by performing an affine transform on the normalized output using the augmented statistics information; and a step of providing the transformed output as an input to the second layer.

A device for training a neural network, in accordance with some embodiments of the described technology to achieve yet another aspect described above, comprises: a storage unit having a computer program stored therein; a memory unit into which the computer program is loaded; and a processing unit for executing the computer program, wherein the computer program comprises: an operation of acquiring a layer output of a first layer of a neural network for training data; an operation of extracting statistics information of the layer output; an operation of generating a normalized output by normalizing the layer output through the statistics information; an operation of generating augmented statistics information associated with the statistics information by augmenting the statistics information; an operation of generating a transformed output by performing an affine transform on the normalized output using the augmented statistics information; and an operation of providing the transformed output as an input to the second layer.

### BRIEF DESCRIPTION OF THE DRAWINGS

FIG. 1 is a block diagram for illustrating a device for training a neural network according to some embodiments of the described technology.

FIG. 2 is a flowchart for illustrating a method for training a neural network and a device thereof according to some embodiments of the described technology.

FIG. 3 is a conceptual diagram for illustrating a method for two-dimensionally training a neural network in a method for training a neural network and device thereof according to some embodiments of the described technology.

FIG. 4 is a conceptual diagram for illustrating a step of extracting statistics information from a layer output of FIG. 2.

FIG. 5 is a conceptual diagram for illustrating a step of normalizing the layer output of FIG. 2 using the statistics information.

FIG. 6 is a conceptual diagram for illustrating a step of generating augmented statistics information by augmenting the statistics information of FIG. 2.

FIG. 7 is a conceptual diagram for illustrating a step of perforating an affine transformation of a normalized output using the augmented statistics information of FIG. 2.

FIG. 8 is a flowchart for illustrating a method for training a neural network and a device thereof according to some embodiments of the described technology.

FIG. 9 is a conceptual diagram for illustrating batches in a method for training a neural network and a device thereof according to some embodiments of the described technology.

FIG. 10 is a conceptual diagram for illustrating the extraction of statistics information according to the batches of FIG. 9.

FIG. 11 is a conceptual diagram for illustrating the generation of augmented statistics information by interpolating the statistics information of FIG. 10.

FIG. 12 is a flowchart for illustrating a method for training a neural network and a device thereof according to some embodiments of the described technology.

FIG. 13 is a flowchart for illustrating a method for training a neural network and a device thereof according to some embodiments of the described technology.

FIG. 14 is a conceptual diagram for illustrating a step of performing convolution on the statistics information in FIG. 13.

FIG. 15 is a flowchart for illustrating a method for training a neural network and a device thereof according to some embodiments of the described technology.

FIG. 16 is a flowchart for illustrating a method for training a neural network and a device thereof according to some embodiments of the described technology.

FIG. 17 is a flowchart for illustrating a method for training a neural network and a device thereof according to some embodiments of the described technology.

FIG. 18 is a flowchart for illustrating a method for training a neural network and a device thereof according to some embodiments of the described technology.

### DETAILED DESCRIPTION

The advantages and features of the disclosed embodiments and methods of achieving them will be apparent when reference is made to the embodiments described below in conjunction with the accompanying drawings. However, the present disclosure is not limited to the embodiments disclosed below but may be implemented in a variety of different forms, and the present embodiments are provided only to make the present disclosure complete and are merely provided to fully convey the scope of the invention to those having ordinary skill in the art.

Terms used herein will be briefly described, and then the disclosed embodiments will be described in detail.

Although the terms used herein have been chosen as generic terms that are widely used at present taking into account the functions of the present disclosure, they may vary depending on the intentions of those having ordinary skill in the art, or precedents, the emergence of new technology, and the like. Further, there may be terms arbitrarily selected by the applicant in some cases, and in that case, the meaning thereof will be described in detail in the following description. Therefore, the terms used in the present disclosure should be defined based on the meanings of the terms and the contents throughout the present disclosure, rather than the simple names of the terms.

A singular-expression in the present specification also encompasses a plural-expression unless clearly indicated in the context that it is singular. Likewise, plural-expressions encompass singular expressions unless clearly indicated in the context that they are plural.

When a part is said to “include” some component throughout the specification, this means that it does not exclude other components but may further include other components unless specifically stated to the contrary.

Further, as used herein, the term “unit” refers to a software or hardware component, and a “unit” performs some functions. However, a “unit” is not meant to be limited to software or hardware. A “unit” may be configured to be in an addressable storage medium and may be configured to operate one or more processors. Thus, as an example, a “unit” encompasses components such as software components, object-oriented software components, class components, and task components, processes, functions, properties, procedures, subroutines, segments of a program code, drivers, firmware, microcode, circuits, data, databases, data structures, tables, arrays, and variables. The functions provided within components and “units” may be combined into a smaller number of components and “units” or further divided into additional components and “units.”

According to an embodiment of the present disclosure, a “unit” may be implemented with a processor and a memory. The term “processor” should be construed broadly to encompass general-purpose processors, central processing units (CPUs), microprocessors, digital signal processors (DSPs), controllers, microcontrollers, state machines, and the like. In some environments, a “processor” may refer to an application-specific integrated circuit (ASIC), a programmable logic device (PLD), a field-programmable gate array (FPGA), or the like. The term “processor” may also refer to a combination of processing devices such as, for example, a combination of a DSP and a microprocessor, a combination of a plurality of microprocessors, a combination of one or more microprocessors coupled with a DSP core, or a combination of any other such components.

The term “memory” should be construed broadly to encompass any electronic component capable of storing electronic information therein. The term “memory” may also refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. If a processor can read and/or write information from/to memory, the memory is said to be in electronic communication with the processor. The memory integrated into a processor is in electronic communication with the processor.

In this specification, a neural network is a term encompassing all kinds of machine learning models designed to mimic neural structures. For example, the neural network may comprise all kinds of neural network based models, such as an artificial neural network (ANN), a convolutional neural network (CNN), and the like.

For convenience, the following describes a method for training a neural network and a device thereof according to some embodiments of the described technology based on a convolutional neural network.

Hereinafter, embodiments will be described in greater detail with reference to the accompanying drawings so that those having ordinary skill in the art to which the present disclosure pertains may readily implement the same. Further, parts that are not relevant to the description will be left out of the drawings to describe the present disclosure clearly.

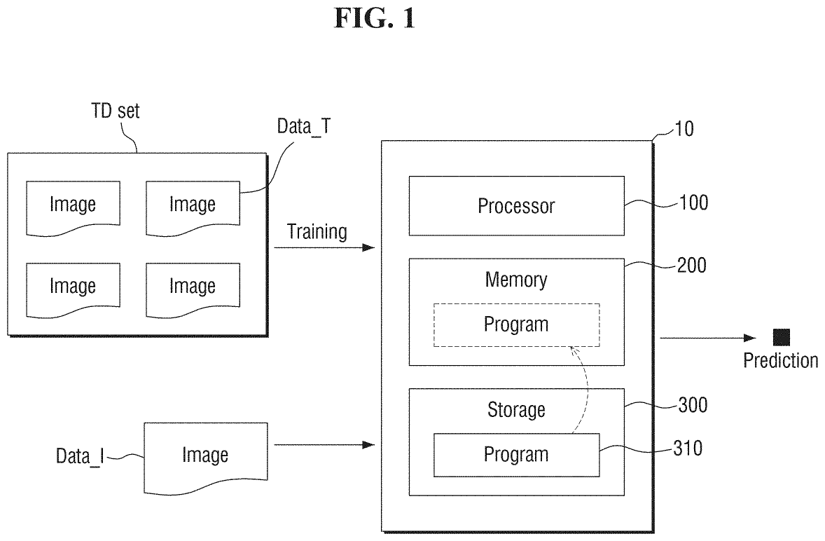

Below, a method for training a neural network and a device thereof according to some embodiments of the described technology will be described with reference to FIG. 1 to FIG. 7.

FIG. 1 is a block diagram for illustrating a device for training a neural network according to some embodiments of the described technology.

Referring to FIG. 1, a device 10 for training a neural network according to some embodiments of the described technology may receive a training data set TD set. In this case, the training data set TD set may comprise at least one training image data data_T.

The device 10 for training a neural network may train the neural network therein with the training data set TD set. Here, the training may mean a process of determining parameters of functions in various layers existing in the neural network. The parameters may comprise weights and biases of the functions. Once the parameters are determined through training, the device 10 for training a neural network may receive inference data Data_I and perform a prediction with the parameters.

The device 10 for training a neural network may comprise a processor 100, a memory 200, and a storage 300. The processor 100 may load a computer program 310 stored in the storage 300 into the memory 200 and execute it. The processor 100 controls the overall operation of respective components of the device 10 for training a neural network. The processor 100 may comprise a central processing unit (CPU), a microprocessor unit (MPU), a microcontroller unit (MCU), a graphics processing unit (GPU), or any type of processor well known in the art. The device 10 for training a neural network may comprise one or more processors 100.

The memory 200 stores various data, commands, and/or information therein. The memory 200 may load one or more computer programs 310 from the storage 300 to execute methods/operations in accordance with various embodiments of the present disclosure. The memory 200 may be implemented with volatile memory such as random access memory (RAM), but the technical scope of the present disclosure is not limited thereto.

When the memory 200 loads the computer program 310, the processor 100 may execute operations and instructions within the computer program 310.

The more the amount of computation of the processor 100 according to the operations of the computer program 310 of the device 10 for training a neural network according to some embodiments of the described technology, the more the capacity of the memory 200 may be required. Therefore, operations of the computer program 310 that require calculation amounts beyond the limit of the capacity of the memory 200 may not perform properly in the device 10 for training a neural network.

The storage 300 may store the computer program 310 therein. The storage 300 may store therein data for the processor 100 to load and execute. The storage 300 may comprise non-volatile memory such as, for example, read-only memory (ROM), erasable programmable ROM (EPROM), electrically erasable programmable ROM (EEPROM), flash memory, and the like, a hard disk, a removable disk, or any type of computer-readable recording medium well known in the art to which the described technology pertains. However, the present embodiment is not limited thereto.

The computer program 310 may comprise an operation for training the device 10 for training a neural network with the training data set TD set and for performing prediction corresponding to the inference data Data_I.

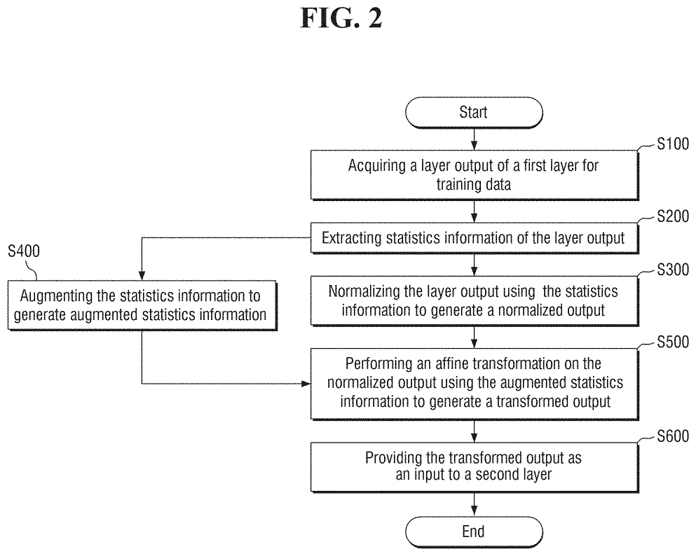

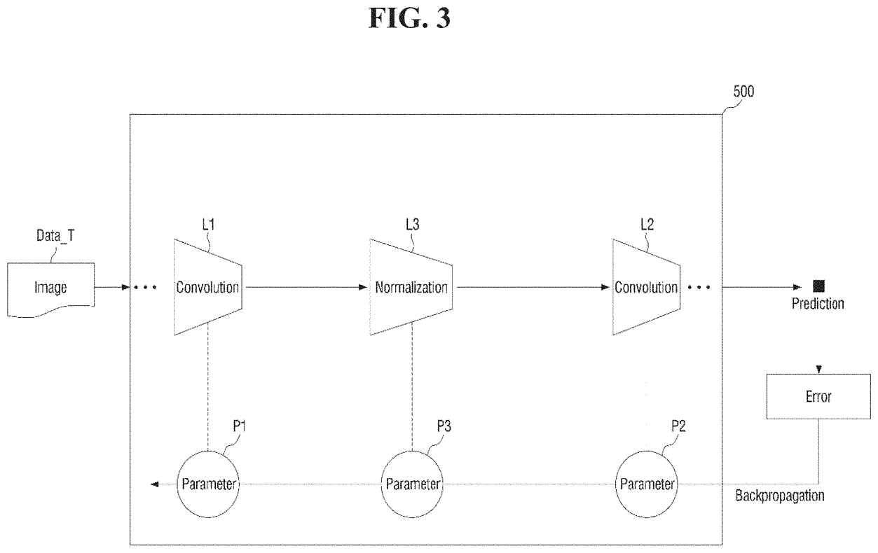

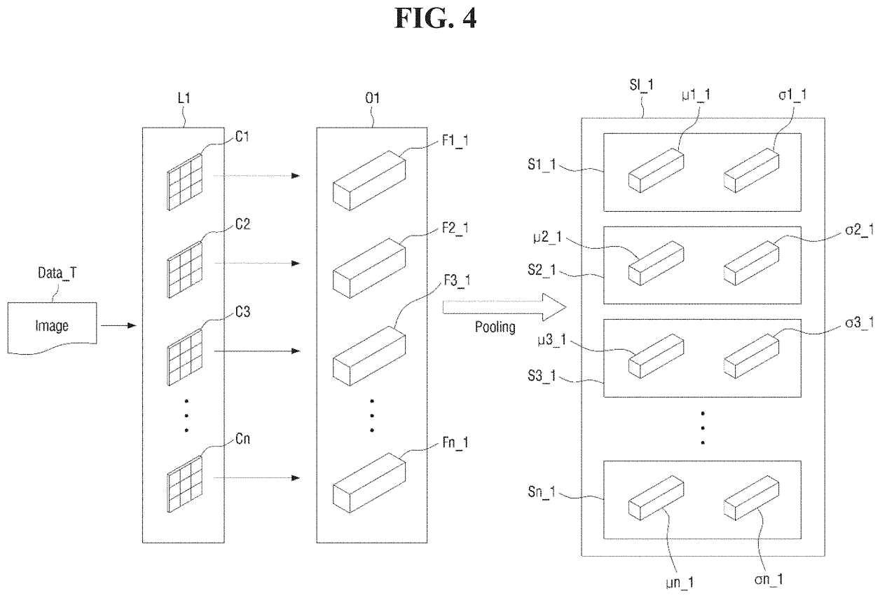

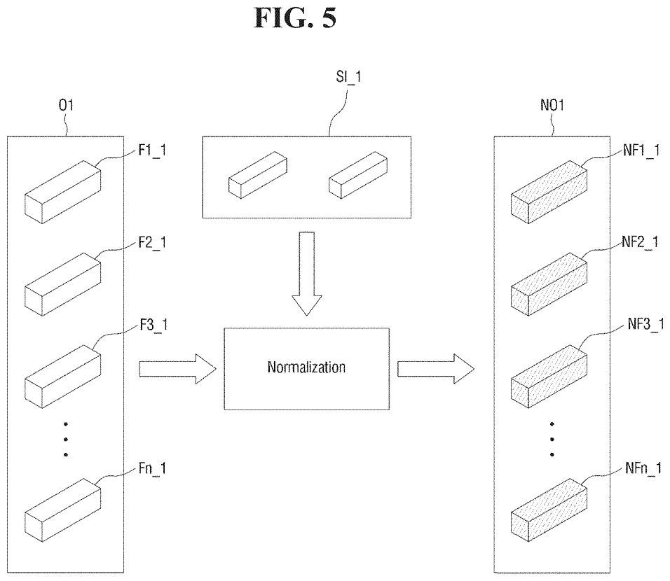

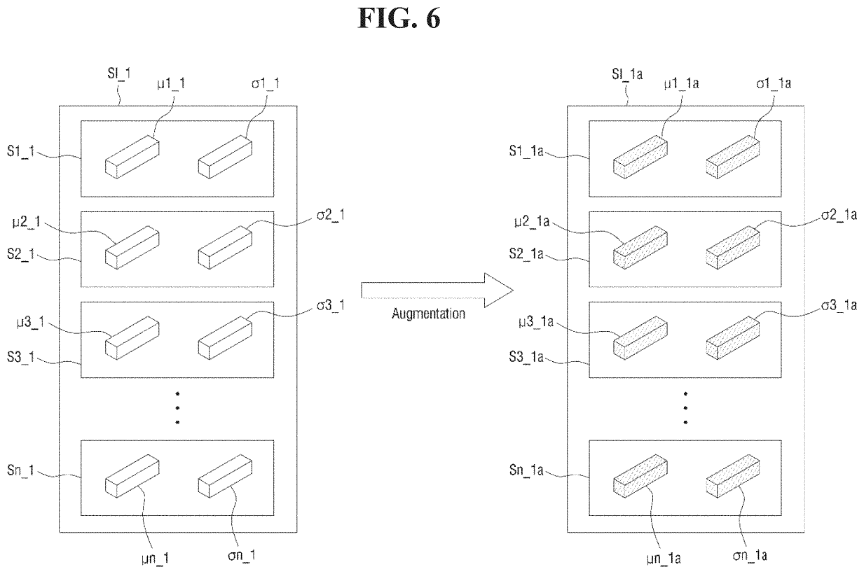

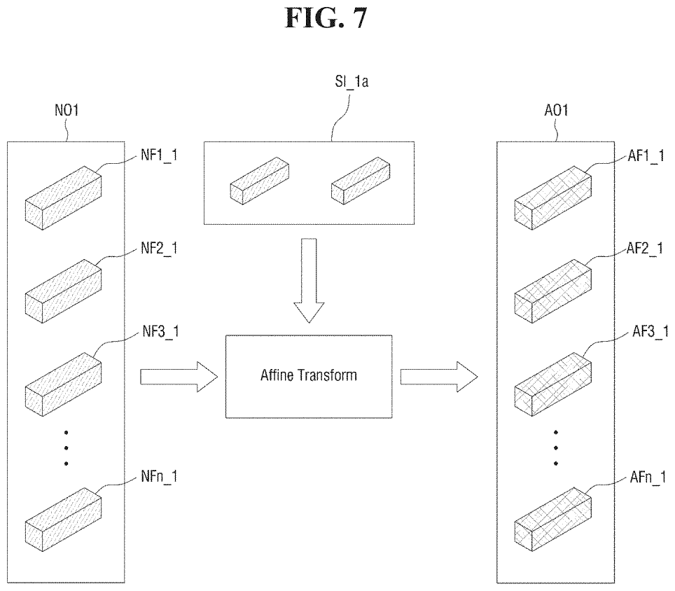

FIG. 2 is a flowchart for illustrating a method for training a neural network and a device thereof according to some embodiments of the described technology, and FIG. 3 is a conceptual diagram for illustrating a method for two-dimensionally training a neural network in a method for training a neural network and device thereof according to some embodiments of the described technology. FIG. 4 is a conceptual diagram for illustrating a step of extracting statistics information from a layer output of FIG. 2, and FIG. 5 is a conceptual diagram for illustrating a step of normalizing the layer output of FIG. 2 using the statistics information. FIG. 6 is a conceptual diagram for illustrating a step of generating augmented statistics information by augmenting the statistics information of FIG. 2, and FIG. 7 is a conceptual diagram for illustrating a step of performing an affine transformation of a normalized output using the augmented statistics information of FIG. 2.

Referring to FIG. 2, a layer output of a first layer is acquired for training data in S100.

Specifically, referring to FIG. 3, the convolutional neural network 500 may be a convolutional neural network (CNN) implemented with the device 10 for training a neural network according to some embodiments of the described technology.

The convolutional neural network 500 may receive the training data data_T, to thereby perform prediction. The convolutional neural network 500 may comprise a plurality of layers. Specifically, the convolutional neural network 500 may comprise a first layer L1, a second layer L2, and a third layer L3.

The first layer L1 may be a lower layer to the third layer L3. That is, the output of the first layer L1 may be provided as an input to the third layer L3. The third layer L3 may be a lower layer to the second layer L2. That is, the output of the third layer L3 may be provided as an input to the second layer L2.

The first layer L1 and the second layer L2 may be, for example, convolutional layers. The convolutional layers may comprise filters for extracting feature maps. Accordingly, the first layer L1 and the second layer L2 may receive the training data Data_T or feature maps that are an output of another convolutional layer, to thereby output new feature maps. Accordingly, the layer output of the first layer may comprise feature maps corresponding to the filters of the first layer L1.

The third layer L3 may be located between the first layer L1 and the second layer L2. The third layer L3 may be a normalization layer. The third layer L3 may serve to provide the feature maps outputted from the first layer L1 as an input to the second layer L2. Steps S100 to S600 of FIG. 2 may be substantially performed in the third layer L3. However, the present embodiment is not limited thereto.

Although not shown in FIG. 3, the convolutional neural network 500 may comprise at least one of an additional convolutional layer, an additional normalization layer, an activation layer, a pooling layer, and a fully-connected layer. However, the present embodiment is not limited thereto.

Though FIG. 3 shows one third layer L3, the present embodiment is not limited thereto. In other words, the number of third layers L3 may vary as desired.

Referring to FIG. 2 again, statistics information of the layer output is extracted in S200.

Specifically, referring to FIG. 4, the first layer L1 may comprise n number of filters C1 to Cn. Each filter may extract a corresponding feature map. More specifically, the first to n^{th} filters C1 to Cn may extract 1_1^{st} to n_1^{st} feature maps F1_1 to Fn_1, respectively. The layer output may comprise a first output O1. The first output O1 may comprise the 1_1^{st} to n_1^{st} feature maps F1_1 to Fn_1.

First statistics information SI_1 may be extracted from the first output O1. The first statistics information SI_1 may comprise 1_1^{st} to n_1^{st} statistics information S1_1 to Sn_1. The 1_1^{st} to n_1^{st} statistics information S1_1 to Sn_1 may comprise 1_1^{st} to n_1^{st} means μ1_1 to μn_1, and 1_1^{st} to n_1^{st} standard deviations σ1_1 to σn_1, respectively. In this case, the 1_1^{st} to n_1^{st} statistics information S1_1 to Sn_1 may be statistics information corresponding to the 1_1^{st} to n_1^{st} feature maps F1_1 to Fn_1, respectively.

In this case, the first statistics information SI_1 may comprise statistics information other than a mean and a standard deviation. For example, the first statistics information SI_1 may comprise a Gram matrix. However, the present embodiment is not limited thereto.

Referring to FIG. 2 again, the layer output is normalized using the statistics information, to generate a normalized output in S300.

Specifically, referring to FIG. 4 and FIG. 5, she first output O1 may be transformed into a first normalized output NO1 through a normalization process. The normalization process may utilize the first statistics information SI_1. Specifically, the normalization process may be a process of subtracting the 1_1^{st} to n_1^{st} means μ1_1 to μn_1 from the 1_1^{st} to n_1^{st} feature maps F1_1 to Fn_1, respectively, and then dividing the result by the 1_1^{st} to n_1^{st} standard deviations σ1_1 to σn_1. That is, the normalization process may proceed as in the equation show n below.

NFi_1=(Fi_1−μi_1)/σi_1

(wherein, i=1, 2, . . . , n)

Here, NFi_1 means an i_1^{st} normalized feature map, and Fi_1 means an i_1^{st} feature map. In addition, μi_1 means an i_1^{st} mean, and σi_1 means an i_1^{st} standard deviation.

The first normalized output NO1 may comprise 1_1^{st} to n_1^{st} normalized feature maps NF1_1 to NFn_1. The 1_1^{st} to n_1^{st} normalized feature maps NF1_1 to NFn_1 may correspond, respectively, to the 1_1^{st} to n_1^{st} feature maps F1_1 to Fn_1 of the first output O1.

Referring to FIG. 2 again, the statistics information is augmented to generate augmented statistics information in S400.

Specifically, referring to FIG. 6, the first statistics information SI_1 may be transformed into first augmented statistics information SI_1a through an augmentation process. The first augmented statistics information SI_1a may comprise 1_1^{st} to n_1^{st} augmented statistics information S1_1a to Sn_1a. The 1_1^{st} to n_1^{st} augmented statistics information S1_1a to Sn_1a may comprise 1_1^{st} to n_1^{st} augmented means μ1_1a to μn_1a, and 1_1^{st} to n_1^{st} augmented standard deviations σ1_1a to σm_1a, respectively. In this case, the 1_1^{st} to n_1^{st} augmented statistics information S1_1a to Sn_1a may correspond to the 1_1^{st} to n_1^{st} normalized feature maps NFn_1, respectively.

In this case, if the first statistics information SI_1 comprises statistics information other than the mean and the standard deviation, the first augmented statistics information SI_1a may comprise corresponding augmented statistics information. For example, if the first statistics information SI_1 comprises a Gram matrix, the first augmented statistics information SI_1a may comprise an augmented Gram matrix. However, the present embodiment is not limited thereto.

In this case, the first augmented statistics information SI_1a may be a value associated with the first statistics information SI_1. Here, “associated” means that the first augmented statistics information SI_1a may be generated based on the first statistics information SI_1, and the style information of a feature map defined by the first augmented statistics information SI_1a may be similar in part to the style information of a feature map defined by the statistics information SI_1. That is, the augmentation process of generating the first augmented statistics information SI_1a may process values of the existing first statistics information SI_1, in which some of the characteristics of the first statistics information SI_1 may remain unchanged. Methods of generating the first augmented statistics information SI_1a will be described in greater detail later.

Referring to FIG. 2 again, an affine transformation is performed on the normalized output using the augmented statistics information, to generate a transformed output in S500.

Specifically, referring to FIG. 7, the first normalized output NO1 may be transformed into a first transformed output AO1 through an affine transformation process. The affine transformation process may use the first augmented statistics information S1_1a. In particular, the affine transformation process may be a process of multiplying the 1_1^{st} to n_1^{st} normalized feature maps NFn_1 by the 1_1^{st} to n_1^{st} standard deviations σ1_1 to σn_1, respectively, and then adding the 1_1^{st} to n_1^{st} means μ1_1 to μn_1 to the result. In other words, the affine transformation process may be performed as in the equation shown below.

AFi_1=NFi_1*σi_1a+μi_1a

(where, i=1, 2, . . . , n)

Here, AFi_1 means an i_1^{st} transform feature map, and NFi_1 means an i_1^{st} normalized feature map. Further, μi_1a means an i_1^{st} augmented mean, and σi_1a means an i_1^{st} augmented standard deviation.

The first transformed output AO1 may comprise 1_1^{st} to n_1^{st} transformed feature maps AF1_1 to AFn_1. The 1_1^{st} to n_1^{st} transformed feature maps AF1_1 to AFn_1 may correspond, respectively, to 1_1^{st} to n_1^{st} normalized feature maps NF1_1 to NFn_1 of the first normalized output NO1.

Referring to FIG. 2, the transformed output is provided as an input to the second layer in S600.

Specifically, referring to FIGS. 3, 4, and 7, the second layer L2 may receive the first transformed output AO1 that is an output of the third layer L3. Thereafter, the second layer L2 may perform convolution on the first transformed output AO1.

The value of the prediction derived at last may be compared with the value of the training output embedded in the training data data_T in the form of a label An error may mean a difference between the values of the training output and the prediction. The convolutional neural network 500 may backpropagate an error to update parameters P1 to P3 of the first layer L1, the second layer L2, and the third layer L3. In this case, the first parameter P1 and the second parameter P2 may be weight and bias parameters of the convolutional layers. That is, the first to n^{th} filters C1 to Cn of the first layer L1 may be included in the first parameter P1. The third parameter P3 of the third layer L3 may be a normalization parameter.

The normalization parameter may comprise a style transform parameter. The style transform parameter may be a learnable parameter, which may be a parameter learned with the neural network. For example, when the error is backpropagated, the value of the third parameter P3 may also be updated along with the first parameter P1 and the second parameter P2 of the neural network.

Through this process, the convolutional neural network 500 may be trained, or may learn. Once the convolutional neural network 500 is trained on all the training data data_T, the parameters P1 to P3 may be determined.

The method for training a neural network and device thereof according to the present embodiments may transform statistics information of a feature map into augmented statistics information. Since the statistics information is associated with the style information among the content information and style information of an image, transforming the statistics information may cause a change in the style information of the training data.

By varying the style information of the training data in a variety of ways, the prediction performance of the neural network may be further improved with respect to inference data of a style different from that of the training data.

Therefore, the method for training a neural network and device thereof according to the present embodiments may modify the existing style information of the training data by augmenting the statistics information into which the style information is encoded. Accordingly, the method for training a neural network and device thereof according to the present embodiments can greatly improve the prediction performance of the neural network for the inference data of a new style.

However, if the style information is changed arbitrarily, there is a risk that the prediction performance of the neural network for the existing style of the training data may be decreased. Therefore, the method for training a neural network and device thereof according to the present embodiments may maintain the prediction performance of the neural network with respect to the existing style of the training data, by changing the style information to style information associated with the existing style information instead of changing the style information arbitrarily.

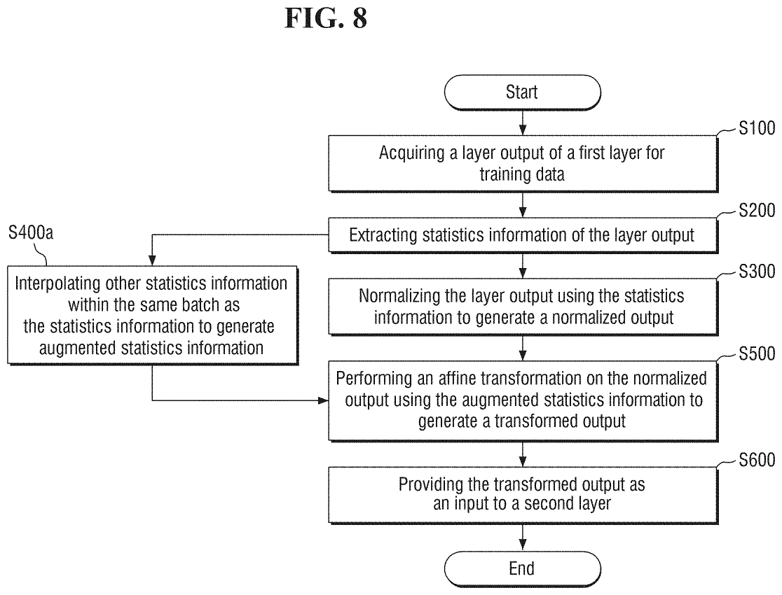

Hereinafter, a method for training a neural network and a device thereof according to some embodiments of the described technology will be described with reference to FIGS. 8 to 11. Parts that may otherwise repeat the same description will be described briefly or omitted.

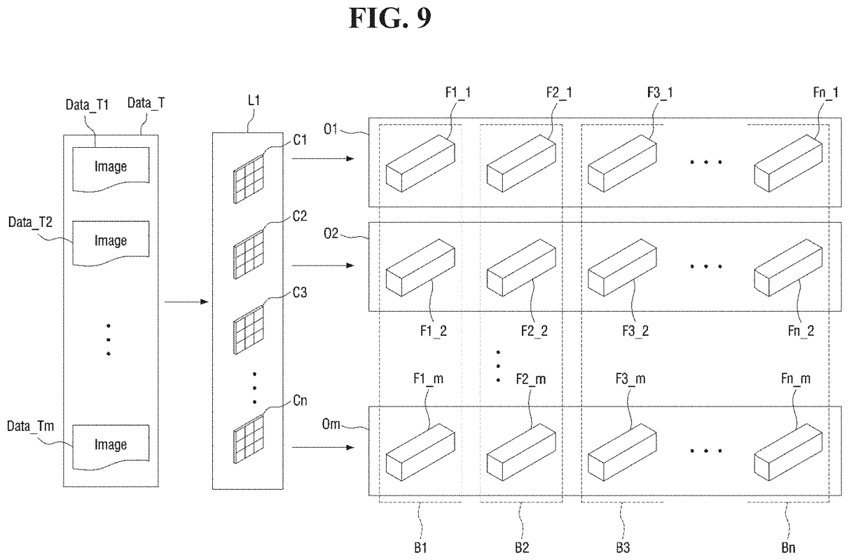

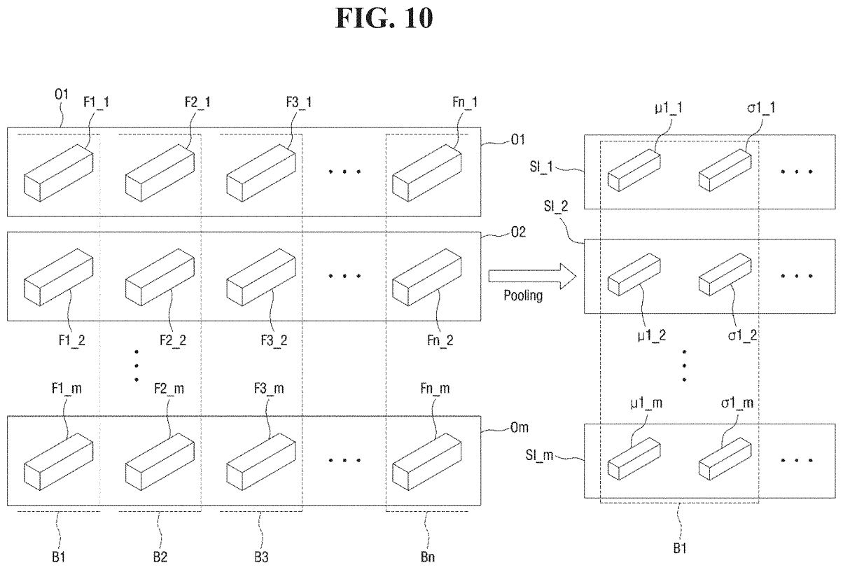

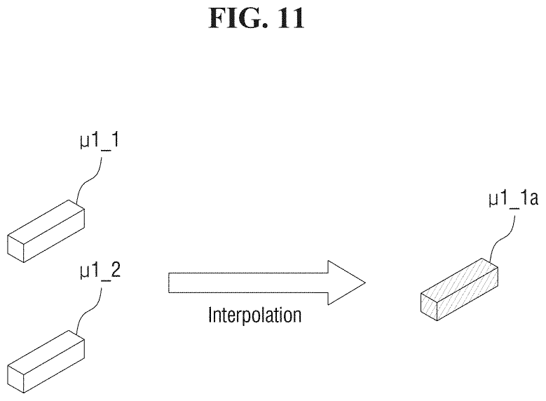

FIG. 8 is a flowchart for illustrating a method for training a neural network and a device thereof according to some embodiments of the described technology, and FIG. 9 is a conceptual diagram for illustrating batches in a method for training a neural network and a device thereof according to some embodiments of the described technology. FIG. 10 is a conceptual diagram for illustrating the extraction of statistics information according to the batches of FIG. 9, and FIG. 11 is a conceptual diagram for illustrating the generation of augmented statistics information by interpolating the statistics information of FIG. 10.

Referring to FIG. 8, steps of S100 to S300, S500, and S600 are the same as in FIG. 2. The step S400 in FIG. 2 may be replaced with step S400a. Below, step S400a will be described.

Augmented statistics information is generated by interpolating other statistics information within the same batch as the statistics information in S400a.

Specifically, referring to FIG. 9, the training data Data_T may comprise first to m^{th} training data Data_T1 to Data_Tm. The first to m^{th} training data Data_T1 to Data_Tm may be individually inputted to the first layer L1.

The first layer L1 may comprise first to nth filters C1 to Cn. In this case, as the first layer L1 comprises n number of filters, the first layer L1 may be defined as having n number of channels. Furthermore, the feature maps extracted by the first to n^{th} filters C1 to Cn may be defined as being associated with the first to n^{th} channels, respectively.

The layer output of the first layer L1 may comprise first to m^{th} outputs O1 to Om. The first to m^{th} outputs O1 to Om may correspond to the first to m^{th} training data Data_T1 to Data_Tm, respectively. Each of the first to m^{th} outputs O1 to Om may comprise a plurality of feature maps. Specifically, the first output O1 may comprise 1_1^{st} to n_1^{st} feature maps F1_1 to Fn_1, and the second output O2 may comprise 1_2^{nd} to n_2^{nd} feature maps F1_2 to Fn_2. The m^{th} output Om may comprise the 1_m^{th} to n_m^{th} feature maps F1_m to Fn_m.

In this case, the 1_1^{st} to 1_m^{th} feature maps F1_1 to F1_m that are associated with the first channel, i.e., that have passed through the first filter C1, may be included in first batch B1. Similarly, second to n^{th} batches B2 to Bn may comprise feature maps associated, respectively, with the second to n^{th} channels. In other words, the first to n^{th} batches B1 to Bn may be collections of feature maps extracted, respectively, by the first to n^{th} filters C1 to Cn.

Referring to FIG. 10, first to m^{th} statistics information SI1 to SIm may be extracted, respectively, from the first to m^{th} outputs O1 to Om. The first to m^{th} statistics information SI1 to SIm may comprise statistics information of the 1_1^{st} to 1_m^{th} feature maps F1_1 to F1_m that are associated with the first channel, i.e., that are extracted by the first filter C1 of FIG. 9. In other words, the first to m^{th} statistics information SI1 to SIm may comprise all of the statistics information of each of the first to n^{th} batches B1 to Bn.

Referring to FIGS. 10 and 11, 1_1^{st} augmented statistics information S1_1a may be generated through interpolation of the statistics information corresponding to the 1_1^{st} to 1_m^{th} feature maps F1_1 to F1_m among the 1_1^{st} statistics information S1_1 with other statistics information within the same batch as the statistics information.

For example, a 1_1^{st} augmented mean μ1_1a of the 1_1^{st} augmented statistics information S1_1a may be generated by interpolating a 1_1^{st} mean μ1_1 and a 1_2^{nd} mean μ1_2. In this case, the 1_2^{nd} mean μ1_2 is included in the first batch B1 and is shown for an illustrative purpose, but the present embodiment is not limited thereto. That is, the present embodiment includes a case where the 1_1^{st} augmented statistics information S1_1a is generated through interpolation of the statistics information corresponding to the 1_1^{st} to 1_m^{th} feature maps F1_1 to F1_m among the 1_1^{st} statistics information S1_1 with any of the statistics information within the same batch as the statistics information. Though FIG. 11 shows only the 1_1^{st} augmented mean μ1_1a of the 1_1^{st} augmented statistics information S1_1a for convenience, other augmented statistics information may also be generated in the same way.

Interpolation of the 1_1^{st} to 1_m^{th} means μ1_1 to μ1_m of the first batch B1 may be performed as in the following equation.

μi_1a=α*μi_1+(1−α)*μi_1

(where, i, j=1, 2, . . . , n, j≠i)

Here, μi_1a means an i_1^{st} augmented mean, and μi_1 means an i_1^{st} mean. Further, μj_1 means a j_1^{st} augmented mean, and both the μi_1 and μj_1 belong to the first batch B1. Here, α may be a value extracted from a uniform function of 0 to 1. The greater the value of α is, the more highly the augmented mean may be associated with the existing mean value.

The interpolation may be performed not only on means but also on standard deviations. That is, the augmented statistics information may be generated by performing interpolation only on means, performing interpolation only on standard deviations, or performing interpolation on both the means and the standard deviations. Although the above description has been described only with respect to the first batch B1 for convenience, the same may be applied to the second to n^{th} batches B2 to Bn.

Specifically, since existing statistics information is used as an input of the interpolation and the information associated with the existing statistics information, i.e., statistics information within the same batch is also used as an input of the interpolation, the transformed augmented statistics information may become different from the existing statistics information but may remain associated therewith. Accordingly, the method for training a neural network and device thereof according to the present embodiments may exhibit improved prediction performance even for the inference data of a new style, and may maintain prediction performance for the inference data of an existing style.

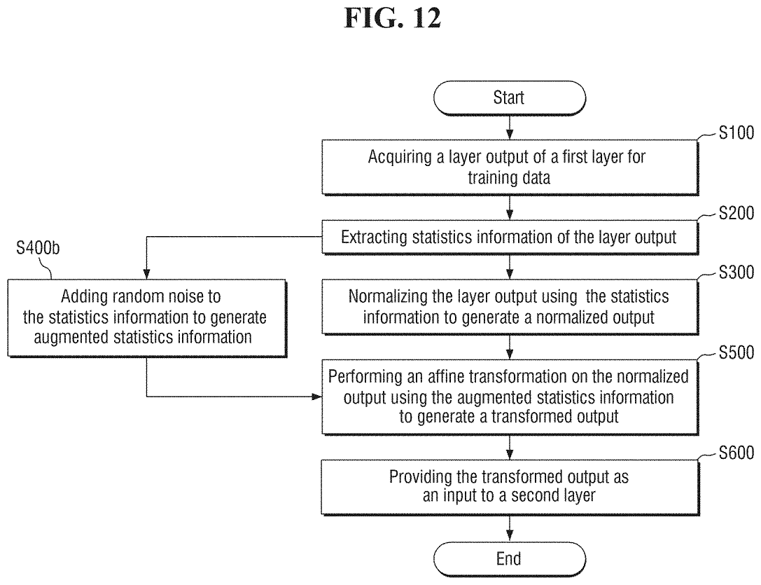

Hereinafter, a method for training a neural network and a device thereof according to some embodiments of the described technology will be described with reference to FIGS. 6 and 12. Parts that may otherwise repeat the same description will be described briefly or omitted.

FIG. 12 is a flow chart for illustrating a method for training a neural network and a device thereof according to some embodiments of the described technology.

Referring to FIG. 12, steps of S100 to S300, S500, and S600 are the same as in FIG. 2. The step S400 in FIG. 2 may be replaced by step S400b. Below, step S400b will be described.

Random noise is added to the statistics information to generate augmented statistics information in S400b.

Specifically, referring to FIG. 6, the first statistics information SI_1 may be transformed into first augmented statistics information SI_1a through an augmentation process in which random noise is added. For example, the random noise may be added to the mean by the following equation:

μi_1a=μi_1*a

(where, i, j=1, 2, . . . , n)

Here, μi_1a means an i_1^{st} augmented mean, and μi_1 means an i_1^{st} mean. Further, a is the random noise, which may have an arbitrary value. Though a may change the magnitude the values of the augmented mean and the existing mean, the range of a may be limited so as not to cause a significant difference. For example, the range of a may be between 0.5 and 1.5, but the present embodiment is not limited thereto.

Alternatively, the random noise may be added by the following equation:

μi_1a=μi_1+b

(where, i, j=1, 2, . . . , n)

In this case, μi_1a means an i_1^{st} augmented mean, and μi_1 means an i_1^{st} mean. Further, b is the random noise, which may have an arbitrary value. Though b may change the magnitude the values of the augmented mean and the existing mean, the range of b may be limited so as not to cause a significant difference. For example, the range of b may be between −0.5*μi_1 and 0.5*μi_1, but the present embodiment is not limited thereto.

Although the above description has been described only with respect to the mean, the same method may be applied to the standard deviation as well. The statistics information of the method for training a neural network and device thereof according to the present embodiments may comprise means and standard deviations, and the addition of the random noise may be performed on the mean and/or standard deviation to generate augmented statistics information.

The method for training a neural network and device thereof according to the present embodiments may change the style of the training data in a simple manner, but may appropriately adjust the degree of the change not to be too large. Accordingly, the method for training a neural network and device thereof according to the present embodiments can readily improve the prediction performance for a new style of the training data while maintaining the prediction performance for the existing style of the training data as well.

Hereinafter, a method for training a neural network and a device thereof according to some embodiments of the described technology will be described with reference to FIGS. 3, 13, and 14. Parts that may otherwise repeat the same description will be described briefly or omitted.

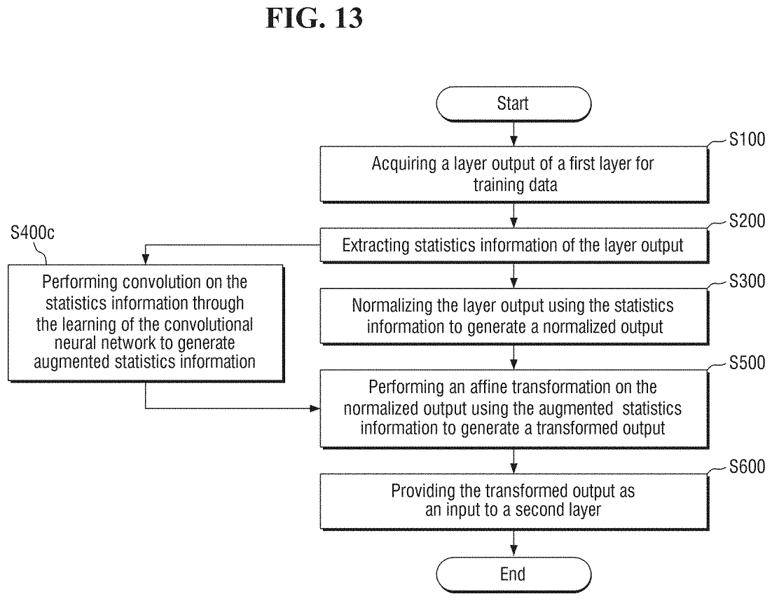

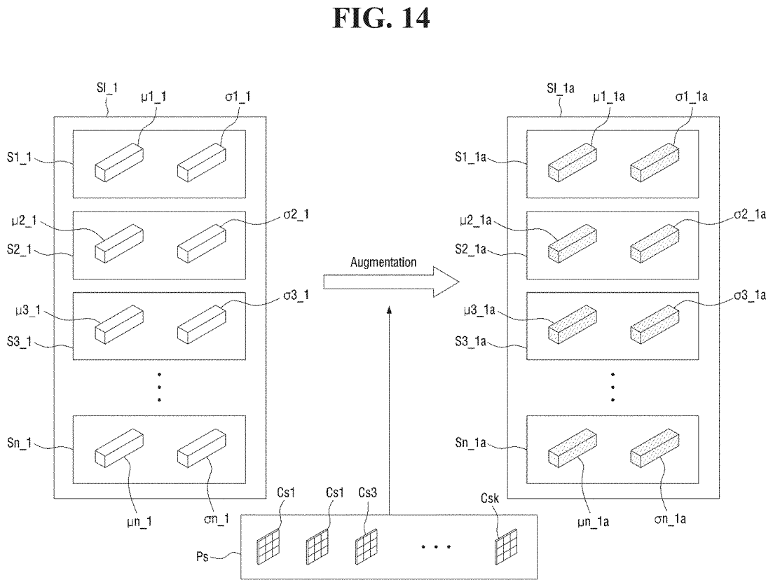

FIG. 13 is a flowchart for illustrating a method for training a neural network and a device thereof according to some embodiments of the described technology, and FIG. 14 is a conceptual diagram for illustrating a step of performing convolution on the statistics information in FIG. 13.

Referring to FIG. 13, steps of S100 to S300, S500, and S600 are the same as in FIG. 2. The step S400 in FIG. 2 may be replaced with step S400c. Below, the step S400c will be described.

Convolution is performed on the statistics information through the learning of the convolutional neural network to generate augmented statistics information in S400c.

Specifically, referring to FIG. 3 and FIG. 14, the first statistics information SI_1 may be transformed into first augmented statistics information SI_1a through an augmentation process. The first statistics information SI_1 may be transformed into the first augmented statistics information SI_1a using a style transform parameter Ps of the convolutional neural network. The style transform parameter Ps may comprise first to k^{th} style transform filters Cs1 to Csk. The first to k^{th} style transform filters Cs1 to Csk may exist in each channel of the layer output of the first layer L1 or may exist one per a plurality of channels. Therefore, the number of style transform filters of the method for training a neural network and device thereof according to the embodiments may vary as desired.

The first statistics information SI_1 may be transformed into the first augmented statistics information SI_1a by reflecting the values of the style transform parameter Ps. At this time, the style transform parameter Ps may be part of the normalization parameter and may be included in the third parameter P3 of the third layer L3.

In this case, the first to k^{th} style transform fillers Cs1 to Csk may be fillers each having a size of 1×1. However, the present embodiment is not limited thereto. In this case, the smaller the sizes of the first to k^{th} style transform filters Cs1 to Csk, the more highly the first statistics information SI_1 is associated with the first augmented statistics information SI_1a.

The method for training a neural network and device thereof according to the present embodiments may transform statistics information into augmented statistics information using a learnable third parameter P3 of the third layer L3. Therefore, optimal augmented statistics information can be generated by using the learning capability of the neural network. Accordingly, the method for training a neural network and device thereof according to the present embodiments can maximize the prediction capability for various styles of a neural network.

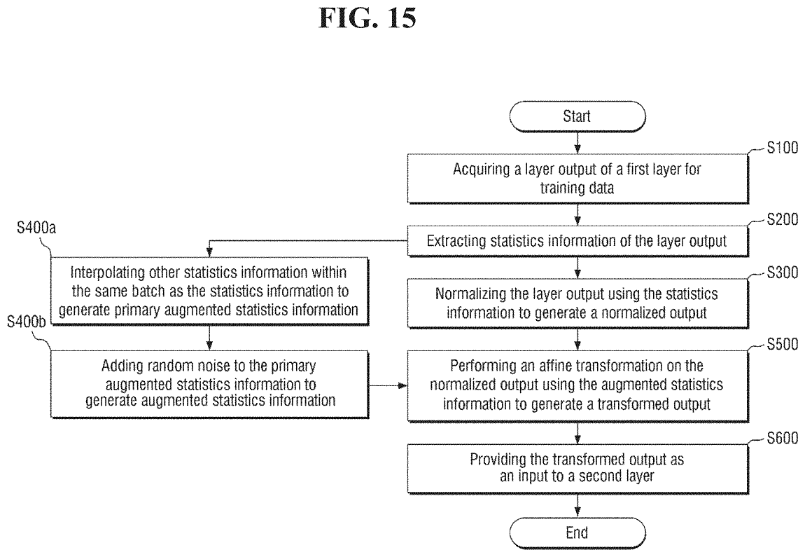

Hereinafter, a method for training a neural network and a device thereof according to some embodiments of the described technology will be described with reference to FIG. 15. Parts that may otherwise repeat the same description will be described briefly or omitted.

FIG. 15 is a flow chart for illustrating a method for training a neural network and a device thereof according to some embodiments of the described technology

Referring to FIG. 15, steps of S100 to S300, S500, and S600 are the same as in FIG. 2. The step S400 in FIG. 2 may be replaced with steps S400a and S400b. Below, the steps S400a and S400b will be described.

First, primary augmented statistics information is generated by interpolating other statistics information within the same batch as the statistics information in S400a.

At this time, the generated primary augmented statistics information may not be final augmented statistics information. The primary augmented statistics information may be transformed into the final augmented statistics information through step S400b described later. The step S400a of generating the primary augmented statistics information is the same as described with respect to FIG. 8.

Thereafter, random noise is added to the primary augmented statistics information, to generate augmented statistics information in S400b.

The step S400b of adding the random noise is the same as described with respect to FIG. 12.

Though FIG. 15 illustrates that the step S400a is performed, followed next by the step S400b, the present embodiment is not limited thereto. In other words, it may also be possible that step S400b is first performed, followed next by the step S400a.

The method for training a neural network and device thereof according to the present embodiments may variously transform statistics information in two ways. Further, the diversity of augmented statistics information can be easily promoted by adding random noise. Accordingly, the prediction performance for the style of a neural network can be robustly augmented in a simple manner.

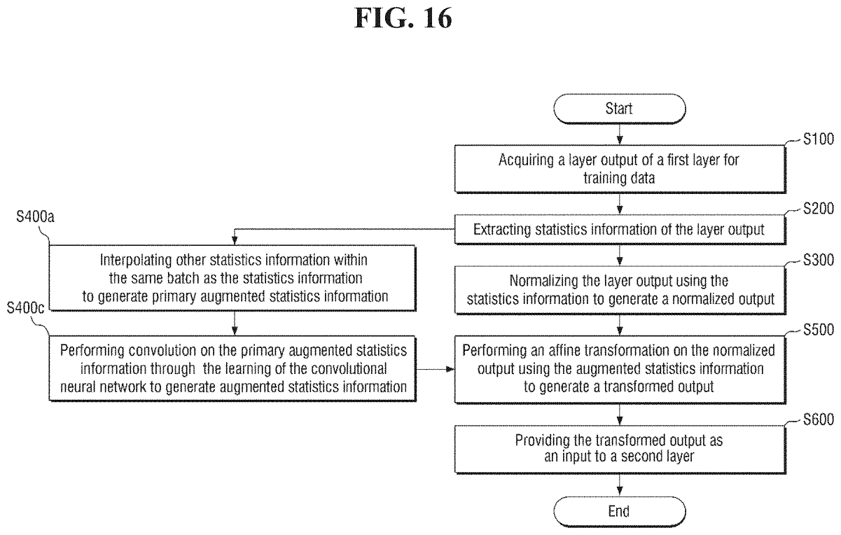

Hereinafter, a method for training a neural network and a device thereof according to some embodiments of the described technology will be described with reference to FIG. 16. Parts that may otherwise repeat the same description will be described briefly or omitted.

FIG. 16 is a flowchart for illustrating a method for training a neural network and a device thereof according to some embodiments of the described technology.

Referring to FIG. 16, steps of S100 to S300, S400a, S500, and S600 are the same as in FIG. 15. The step S400b in FIG. 15 may be replaced by step S400c. Below, the step S400c will be described.

Convolution is performed on the primary augmented statistics information through the learning of the convolutional neural network, to generate augmented statistics information in S400c.

The step S400c of generating augmented statistics information through convolution is the same as the description of step S400c of FIG. 13.

Though FIG. 16 illustrates that the step S400a is performed, followed next by the step S400c, the present embodiment is not limited thereto. In other words, it may also be possible that step S400c is first performed, followed next by the step S400a.

The method for training a neural network and device thereof according to the present embodiments may variously transform statistics information in two ways of interpolation and convolution. Furthermore, since the convolutional neural network can be used to find optimal augmented statistics information, it is possible to more robustly and safely augment the prediction performance for the style of the neural network.

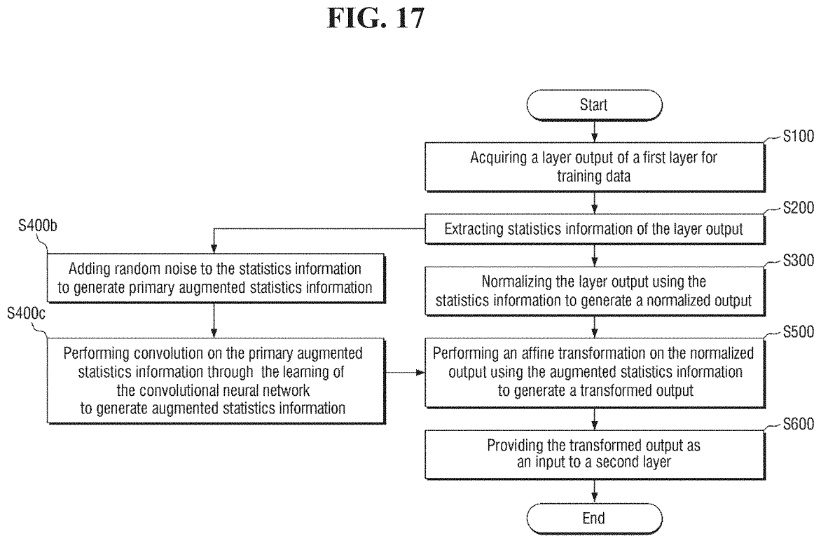

Hereinafter, a method for training a neural network and a device thereof according to some embodiments of the described technology will be described with reference to FIG. 17. Parts that may otherwise repeat the same description will be described briefly or omitted.

FIG. 17 is a flowchart for illustrating a method for training a neural network and a device thereof according to some embodiments of the described technology.

Referring to FIG. 17, steps of S100 to S300, S400c, S500, and S600 are the same as in FIG. 16. The step S400a in FIG. 16 may be replaced by step S400b. Below, the step S400b will be described.

Random noise is added to the statistics information to generate primary augmented statistics information in S400b.

At this time, the generated primary augmented statistics information may not be final augmented statistics information. The primary augmented statistics information may be transformed into the final augmented statistics information through step S400c described later. The step S400b of generating the primary augmented statistics information is the same as described with respect to FIG. 12.

Though FIG. 17 illustrates that the step S400b is performed, followed next by the step S400c, the present embodiment is not limited thereto. In other words, it may also be possible that step S400c is first performed, followed next by the step S400b.

The method for training a neural network and device thereof according to the present embodiments may variously transform statistics information in two ways of an addition of random noise and convolution. Thus, since the statistics information can be easily transformed in a simple manner and the convolutional neural network can be used to find optimal augmented statistics information, it is possible to more easily and robustly augment the prediction performance for the style of the neural network.

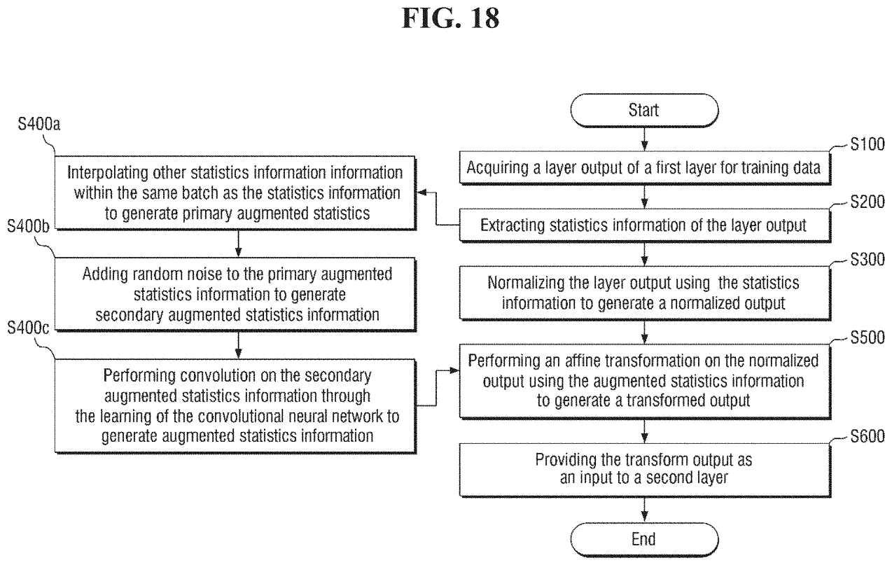

Hereinafter, a method for training a neural network and a device thereof according to some embodiments of the described technology will be described with reference to FIG. 18. Parts that may otherwise repeat the same description will be described briefly or omitted.

FIG. 18 is a flowchart for illustrating a method for training a neural network and a device thereof according to some embodiments of the described technology.

Referring to FIG. 18, steps of S100 to S300, S500, and S600 are the same as in FIG. 2. The step S400 in FIG. 2 may be replaced with steps S400a, S400b, and S400c. Below, the steps S400a, S400b and S400c will be described.

First, primary augmented statistics information is generated by interpolating other statistics information within the same batch as the statistics information in S400a.

At this time, the generated primary augmented statistics information may not be final augmented statistics information. The primary augmented statistics information may be transformed into the final augmented statistics information through steps S400b and S400c described later. The step S400a of generating the primary augmented statistics information is the same as described with respect to FIG. 8.

Thereafter, random noise is added to the primary augmented statistics information to generate secondary augmented statistics information in S400b.

At this time, the generated secondary augmented statistics information may not be final augmented statistics information. The secondary augmented statistics information may be transformed into the final augmented statistics information through step S400c described later. The step S400b of generating the secondary augmented statistics information is the same as the description with respect to FIG. 12.

Next, convolution is performed on the secondary augmented statistics information through the learning of the convolutional neural network, to generate augmented statistics information in S400c.

The step S400c of generating augmented statistics information through convolution is the same as the description of step S400c of FIG. 13.

Though FIG. 18 illustrates that the steps S400a, S400b, and S400c are performed sequentially, the present embodiment is not limited thereto. In other words, it may also be possible to perform the steps S400a, S400b, and S400c in different orders.

The method for training a neural network and device thereof according to the present embodiments may variously transform statistics information in three ways of interpolation, an addition of random noise, and convolution. Therefore, it is possible to augment the prediction performance for the style of the neural network in the most effective way.

Although embodiments of the described technology have been described above with reference to the accompanying drawings, it will be understood by those having ordinary skill in the art to which the described technology pertains that the described technology can be implemented in other specific forms without changing the technical spirit or essential features thereof. Therefore, it should be understood that the embodiments described above are not restrictive.

What is claimed is:

1. A method for training a neural network comprising first and second layers in a computing device, the method comprising:
acquiring, at a processor of the computing device, a layer output of the first layer for training data;
extracting, at the processor, statistics information of the layer output;
normalizing, at the processor, the layer output through the statistics information to generate a normalized output;
augmenting, at the processor, the statistics information to generate augmented statistics information associated with the statistics information;
performing, at the processor, an affine transform on the normalized output using the augmented statistics information to generate a transformed output; and
providing, at the processor, the transformed output as an input to the second layer.

2. The method of claim 1, wherein the neural network is a convolutional neural network (CNN), and
wherein the layer output comprises feature maps.

3. The method of claim 2, wherein the training data comprises first and second training data,
wherein the feature maps comprise first and second feature maps associated with a first channel and third and fourth feature maps associated with a second channel, the first and third feature maps being associated with the first training data, and the second and fourth feature maps being associated with the second training data,
wherein the statistics information comprises first to fourth statistics information corresponding, respectively, to the first to fourth feature maps, and
wherein normalizing the layer output comprises:
normalizing the first to fourth feature maps, respectively, using the first to fourth statistics information.

4. The method of claim 3, wherein the first and second feature maps are included in a first batch,
wherein the third and fourth feature maps are included in a second batch, and
wherein generating the augmented statistics information comprises:
generating first to fourth augmented statistics information corresponding, respectively, to the first to fourth statistics information,
wherein the first augmented statistics information is generated by interpolating the first statistics information and the second statistics information, and
wherein the third augmented statistics information is generated by interpolating the third statistics information and the fourth statistics information.

5. The method of claim 4, wherein generating the first augmented statistics information comprises adding random noise to the statistics information.

6. The method of claim 5, wherein generating the first augmented statistics information comprises performing convolution on the statistics information through learning of the convolutional neural network.

7. The method of claim 4, wherein generating the first augmented statistics information comprises performing convolution on the statistics information through learning of the convolutional neural network.

8. The method of claim 1, wherein the statistics information comprises at least one of a mean, a standard deviation, or a gram matrix, and
wherein the augmented statistics information comprises at least one of an augmented mean, an augmented standard deviation, or an augmented gram matrix.

9. The method of claim 8, wherein generating the augmented statistics information comprises adding random noise to at least one of the mean and standard deviation.

10. The method of claim 1, wherein generating the augmented statistics information comprises performing convolution on the statistics information through learning of a convolutional neural network to generate the augmented statistics information.

11. The method of claim 10, wherein performing convolution on the statistics information comprises performing convolution with a 1×1 filter.

12. A non-transitory computer-readable recording medium comprising computer-executable instructions, when executed, configured to cause a processor to perform a method for training a neural network comprising first and second layers, the method comprising:
acquiring, at the processor, a layer output of a first layer of a neural network for training data;
extracting, at the processor, statistics information of the layer output;
generating, at the processor, a normalized output by normalizing the layer output through the statistics information;
generating, at the processor, augmented statistics information associated with the statistics information by augmenting the statistics information;
generating, at the processor, a transformed output by performing an affine transform on the normalized output using the augmented statistics information; and
providing, at the processor, the transformed output as an input to the second layer.

13. The recording medium of claim 12, wherein the neural network is a convolutional neural network,
wherein the layer output is feature maps,
wherein the statistics information is statistics information of the feature maps, and
wherein generating the augmented statistics information comprises:
interpolating with statistics information of another feature map within the same batch of the feature maps.

14. A device for training a neural network comprising:
a memory configured to store computer-executable instructions; and
a processor in data communication with the memory and configured to execute the computer-executable instructions to:
acquire a layer output of a first layer of a neural network for training data;
extract statistics information of the layer output;
generate a normalized output by normalizing the layer output through the statistics information;
generate augmented statistics information associated with the statistics information by augmenting the statistics information;
generate a transformed output by performing an affine transform on the normalized output using the augmented statistics information; and
provide the transformed output as an input to the second layer.

15. The device of claim 14, wherein the neural network is a convolutional neural network,
wherein the layer output comprises feature maps,
wherein the statistics information comprises statistics information of the feature maps, and
wherein generating the augmented statistics information comprises:
interpolating with statistics information of another feature map within the same batch of the feature maps.
